(19) United States
(12) Patent Application Publication
(10) Pub. No.: US 2009/0294671 A1
(43) Pub. Date: Dec. 3, 2009

(54) Target brightness

(76) Inventor: Shahin Baghai, Trumbull, CT (US)

Correspondence Address: WILLIAM ANTHONY DRUCKER, Unit # 208, 610 N. West Street, Alexandria, VA, 22314, US

(21) Appl. No.: 11/980,038

(22) Filed: Oct. 30, 2007

Related U.S. Application Data
(63) Continuation-in-part of application No. 10/882,924, filed on Jul. 1, 2004, now abandoned.
(60) Provisional application No. 60/486,951, filed on Jul. 14, 2003.

(51) Int. Cl. G01J 5/00

(52) U.S. Cl. 250/338.1

(57) ABSTRACT

An infrared measurement method and device is described having light projecting target sighting means. Changing the sighting display controls brightness of the sighted target. Automatic brightness control of the target is provided by a light sensor and/or according to target distance. Switching the display light into different patterns changes brightness, which is also changed by changing the electrical supply to the sighting light and by optical attenuation of the sighting light.

This application is a continuation-in-part of copending application Ser. No. 10/882,924 filed Jul. 1, 2004 for Laser Brightness, which application claims benefit from Provisional Application U.S. No. 60/486,951 filed Jul. 14, 2003, the disclosure of which is incorporated herein by reference.

This invention relates to the use of light beams to identify the location and size of a measurement target on a surface area for non-contact remote measurement (e.g. temperature) or for treatment; and in particular relates to controlling the brightness of a light display pattern projected by a sighting system onto said target, which light display is used to locate and to visualize an otherwise invisible energy zone of infrared radiation from said target, normally not visible to the naked eye.

It is known in the art of non-contact temperature measurement to direct an infrared radiometer, having a field of view, at a remote target surface to measure invisible heat radiation emanating therefrom; and by imaging the target via infrared optics onto the detector to identify the target location, distance and size by projecting and sighting one or more visible light beams onto the target so that the radiometer user can visualize an optically perceptible target and identify the target area detected by the radiometer and so direct the radiometer to the target area of the energy zone.

It is also known to use either moving (dynamic) or stationary light beams for sighting and targeting and to project one or more beams onto the target surface to indicate and to display the target area. More than one light source may be used for this sighting, such as multiple laser beam emitters, multiple light emitting diodes or halogen lamps or a combination of these sources, any of which may pulsate for higher visibility. Intersection of multiple beams on the target is a basis for a microprocessor to calculate and adjust projected light brightness for target distance. A single central spot may be formed from one or more beams or a dispersed pattern of at least three spots may be used to define the measurement area and/or to outline the energy zone. The light source of the sighting device is conveniently mounted together with a radiometer on a common hand held support of pistol style for direction of aiming light onto the target surface.

When light projection target sighting is used with a temperature measurement or control device, there are limiting operational features. The light display on the target surface must be bright enough to be seen on the target in ambient operating conditions, even at substantial distance from the instrument, but not be so bright as to cause eye damage. At times the beam must penetrate fog or vapor or fumes to illuminate the target so that the light display on the target may be seen clearly. It is useful to provide variable brightness of the light display on the target surface. Target brightness is managed in the various ways described herein.

Some instruments use sighting lasers at the lowest workable brightness, which is cheaper and safer, since brighter lasers require greater safety regulation and control and greater power. Battery power is preferred in a handheld device.

The present invention provides a device and method wherein target sighting brightness is controlled within safety limits. This control is automatic by a microprocessor, according to ambient light and/or ambient temperature and/or target distance from the detector and according to the character of a particular display pattern, e.g., a central spot and/or a circular peripheral outline spot display, or is switchable either automatically through a microprocessor or selectably by the operator. Variable target brightness is a feature of the invention.

### PRIOR ART

It is known from HOLLANDER (U.S. Pat. No. 6,377,400) and (U.S. Pat. No. 6,614,830) and (U.S. Pat. No. 6,633,434) and (U.S. Pat. No. 659,639) and (U.S. Pat. No. 6,901,089) to (a) project a sighting beam through an opening of selected size, shape or diameter and/or (b) to change an aiming light display pattern to alter or to attenuate beam brightness when measuring temperature. It is also known to attenuate beam brightness by passage across a diffraction lens. It is known in the firearm art from KRANICH (U.S. Pat. No. 6,363,348) to use a laser intensity adjustment mechanism controlled by the operator to aim a firearm.

Brightness of sighting beams and target surface is increased or decreased to a useful extent by switching more or less beams into or out of operation, as well as by adjusting brightness of separate beams. For example, one may form selectively either a single separate central spot from one or more beams; and/or a circle of spots outlining the energy zone is used, and in the present invention the light display brightness is managed by use of more or less beams by switching so that the display on the target is brighter when more beams operate. Brightness is managed by optical attenuation, such as by interposition of an optical element between a light source and the target, such as a diffraction lens or the iris diaphragm or by an optical brightness filter as used in photography. A best mode of brightness control is by change of electrical power supply to the light source as by use of a resistor, which may be fixed, or variable.

In accordance with the invention, either the operator alone, manually or in combination with an automatic sensor and microprocessor control means (which may also function without operator intervention), varies the brightness of the sighting light and of the target brightness display derived therefrom to control visibility and safety limits, so that the target display is both safe to the eye and useful to see for aiming the device. when the target measurement area is located at a relatively long distance away from the instrument, or in obscure illumination conditions greater refulgence is valuable. The brightness of the target is controlled via microprocessor from detectors of ambient light and/or temperature, target distance and the setting of the display switch, which selects the number of lamps in use and the character of the display pattern (e.g., a single central spot and/or an outline circular target illumination).

For commercial and safety reasons, laser devices are commonly classified in brightness as Class 2 (less than 1 milliwatt), or Class 3A (less than 5 milliwatt), or Class 3B (more than 5 milliwatt), as measured under standardized conditions. Brighter lasers require greater safety regulation and control. Use of the lowest workable brightness is cheaper and safer. According to the invention, means are employed to obtain optimal safe illumination of a target measurement or treatment area on a remote surface. A sighting laser light source of power output between 0.3 milliwatts and about 5.0 milliwatts best controls target brightness.

Brightness of one or more light sighting elements (e.g. laser emitters or LEDs) mounted upon a hand held measurement instrument (e.g. radiometer with a temperature display and/or a distance measurement display) with integral power supply may be controlled by pulsation and/or by selection of the number and strength of light elements (e.g. pattern switching) used separately or together and managed by automatic microprocessor response. For example, a light sensor to ambient illumination located near a laser provides a target brightness display of optimal character to match working conditions and is managed by microprocessor. Any or all of the sighting light elements are mounted to tilt or swivel so that beams are directable most effectively onto the target surface to form a display; and combinations of selectable and/or switching of lamps are provided when changing brightness between display of a single central aiming spot and/or a switch position selected to display the outline of the target area, for example, as an outline circle of spots. The following control methods illustrate the invention.

Manually or automatically adjusting target display light brightness based upon ambient light measurement near the target surface display.

Manually or automatically adjusting target light brightness based on distance measured to the target. Distance is conveniently determined by sonic ranging or by optical rangefinder operated by the sighting beams.

Manually or automatically adjusting brightness based upon target display pattern configuration, such as laser dot/circle switching.

Manually or automatically adjusting target light brightness based on ambient temperature near a laser. For example, laser brightness changes with a change in ambient temperature.

### EXAMPLES

The invention is next described, by way of examples, with reference to the accompanying DRAWING, in which

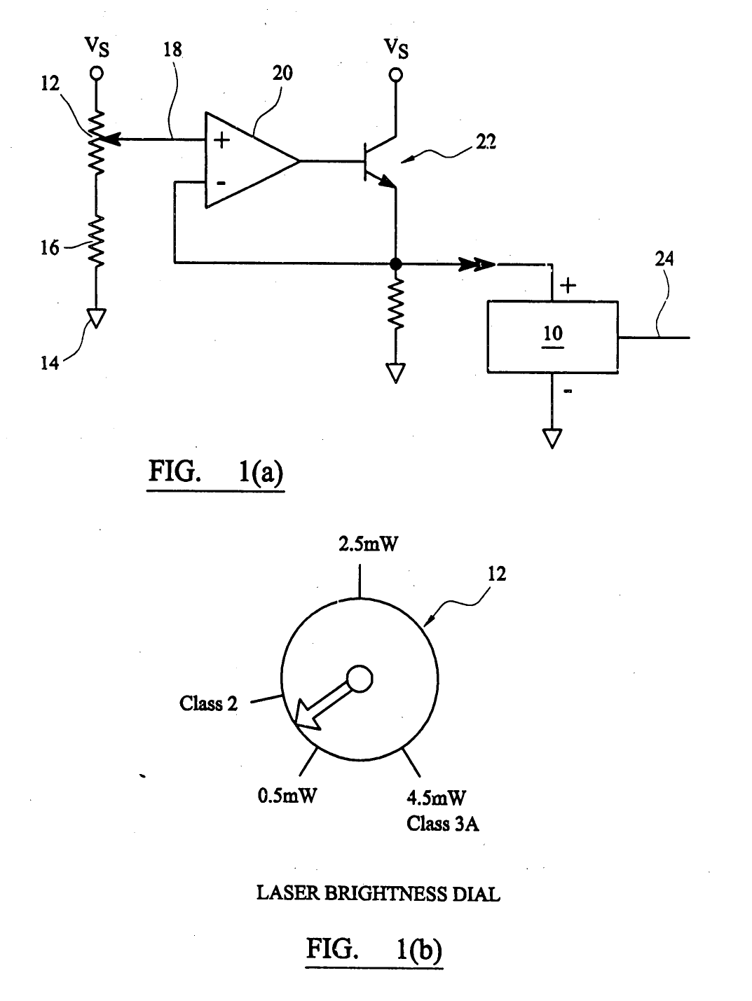

FIG. 1(a) is a circuit diagram of an electrical method, apparatus and system for target brightness management, and FIG. 1(b) is a detail of a potentiometer used;

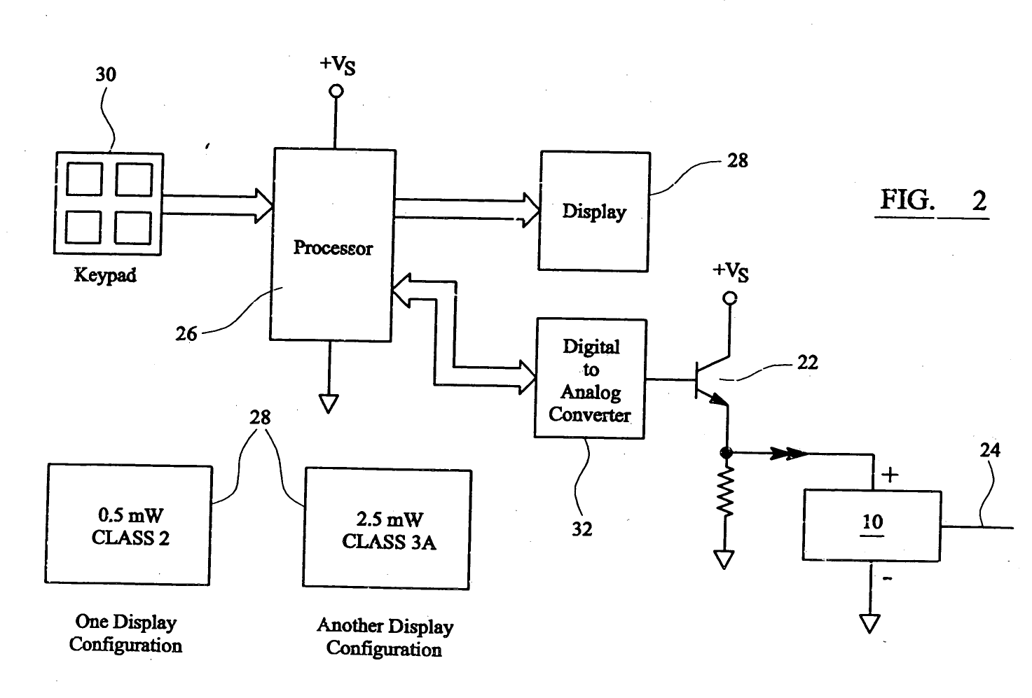

FIG. 2 is a circuit diagram of a brightness control system employing a microprocessor; and

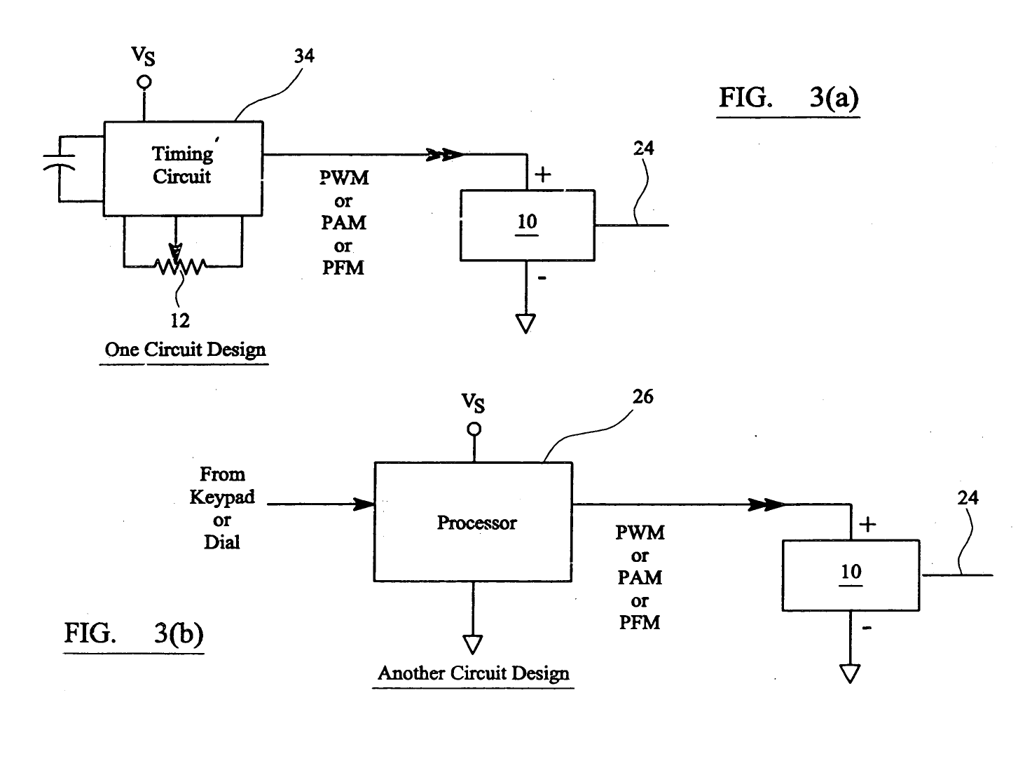

FIGS. 3(a) and (b) are diagrams of control devices employing power modulation for brightness management;

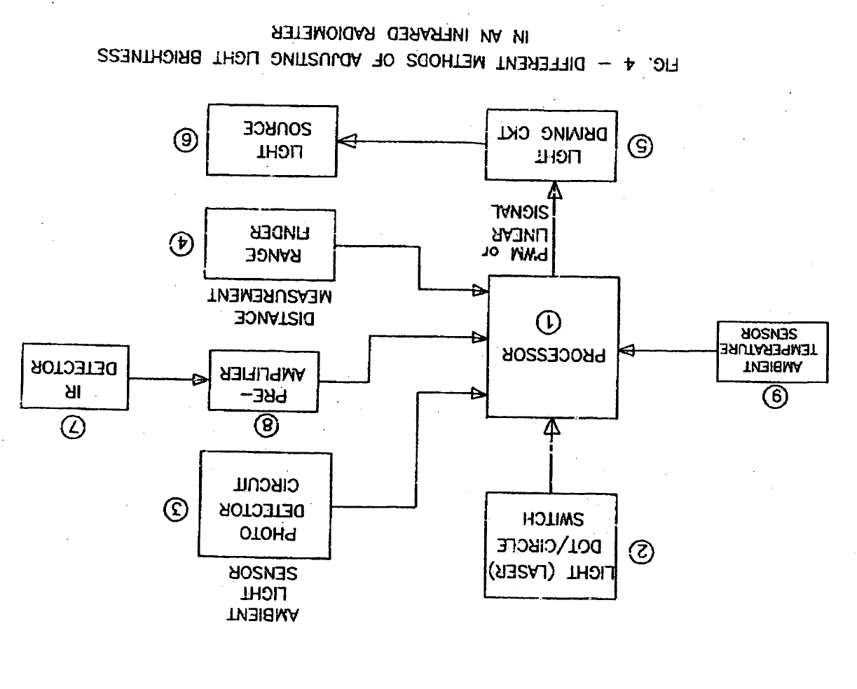

FIG. 4 is a diagram showing methods of adjusting target light display brightness in an infrared radiometer. A microprocessor controls target brightness responsive to signals from detectors such as display switch position, ambient light/temperature and target distance.

Referring to the DRAWING, and in particular FIG. 1, there is illustrated a power/brightness control system circuit for a light source device or module (10) (LED or laser) which comprises a potentiometer (12) connected between a voltage supply V, and ground (14) through a resistor (16). The output (18) from the potentiometer (12) goes to an amplifier (20) and to a transistor (22), in turn connected to the light source (10). Variation of the potentiometer (12) varies the power fed to the source (10) accordingly. The source device (10) emits a light beam (24), the brightness of which varies in step with changes in power. The potentiometer (12) is illustrated in detail in FIG. 1(b), where a dial is labeled to indicate the level of optical power and target brightness. For example, the dial indicates selectably from 0.5 to 4.5 milliwatts with indication marks for Class 2 and for Class 3A limits. The potentiometer (12) is a single turn switch, a slide switch or a swing arm step switch.

Turning to FIG. 2, the brightness control system illustrated here includes a micro-processor (26) connected to a display (28) and having a keypad input (30). Output from the processor (26) is connected, via a digital to analog converter (32) and a transistor (34), to a voltage supply V, to a light source (10) as before. The key pad (30) is used to adjust the power output and, as the keypad adjusts the output, the display (28) indicates the brightness and classification limit, e.g. as shown in FIG. 2.

Light display methods involve pulsing, such as pulse width modulation (PWM) or pulse amplitude modulation (PAM), as shown in FIG. 3. In FIG. 3(a), the width of the pulse is varied in proportion to brightness by a timing circuit (34). In FIG. 3(b), a processor (26) is employed to vary the width, amplitude or frequency of the power pulse in proportion to brightness. Various pulse modulation modes are used individually or together sequentially in the same device or used simultaneously.

FIG. 4 shows different ways of adjusting target brightness for a radiometer based upon ambient light, target distance and light switch status by the use of a processor (1) which manages the target light display from sensing a switch (central dot and/or outline circle) (2), and/or from an ambient light sensor/photo detector circuit, and/or from an ambient temperature detector (3), and/or from a target distance measurement range finder (4), which may be sonic or optical; and controlling a light driving circuit (5) connected to an aiming light source (6). The distance and ambient light controls work either separately or together. An infrared detector (7) and/or an ambient temperature sensor (9) measures target temperature with output signal going to a preamplifier (8), which feeds the heat signal information to the processor (1).

The main processor (1) sends a pulse width modulation signal (PWM) to the light driving circuitry (5), which in turn drives a light source (6) such as a light emitting diode or a laser module. The PWM signal from the processor controls the target brightness. The processor (1) detects the ambient light close to the target via a photo detector circuit (3). The more ambient light around the target, the more light brightness is needed to be projected onto the target. The processor adjusts brightness automatically based either or both upon target distance as measured by a range finder and/or the ambient light photo detector circuit. The range finder (4) measures the distance to the target. The longer the distance, the brighter the light must be to outline the energy zone. The processor adjusts brightness in response to distance measurement.

The processor monitors a light switch as a central dot/circle switch, and automatically adjusts target brightness with respect to switch status and according to the number of separate lamps in operation. More brightness is needed for a circle than for a central dot alone.

The processor monitors ambient temperature (9) near a laser and adjusts light source brightness accordingly so that target brightness is maintained even when there is a change in ambient temperature. For example laser brightness changes with ambient temperature. The processor controls and maintains laser brightness at a selected value regardless of change in ambient temperature.

The present invention enables a simple and inexpensive control of the light beams providing target brightness in an infrared detection system to produce optimal brightness and visibility within safety margins.

What is claimed is:

1. An infrared radiometer comprising a detector of heat radiation and a light projecting electrical sighting means which identifies a remote target surface area for aiming the detector; in combination with means controlling the brightness of illumination of said surface by said sighting means in response to detection of target brightness parameters such as target distance, ambient light and target display status.

2. A radiometer as claimed in claim 1 wherein brightness is increased or decreased by switching more or less sighting light into or out of operation.

3. A radiometer as claimed in claim 1 wherein target brightness is managed by optical attenuation means.

4. A radiometer as claimed in claim 1 wherein target brightness is managed by changing electrical supply to the sighting means.

5. A method of controlling the target sighting brightness of a radiometer according to operational needs, which comprises monitoring ambient light and/or temperature conditions, target distance and sighting beam display pattern and adjusting target brightness through a microprocessor.

6. A method of claim 5 in which brightness is managed by switching sighting lights and display patterns into and out of operation.

7. A method of claim 5 wherein target brightness is controlled by optical attenuation of the sighting light.

8. A method of claim 5 wherein target brightness is managed by variation of the electric supply to the sighting light.
